(19) United States
(12) Patent Application Publication
(10) Pub. No.: US 2025/0226893 A1
(43) Pub. Date: Jul. 10, 2025

(54) MODEL-BASED DECISION FEEDBACK DETECTION FOR OPTICAL COMMUNICATION

(71) Applicant: SIGNIFY HOLDING B.V., EINDHOVEN (NL)

(72) Inventor: JOHAN PAUL MARIE GERARD LINNARTZ, EINDHOVEN (NL)

(21) Appl. No.: 18/851,272

(22) PCT Filed: Mar. 27, 2023
(86) PCT No.: PCT/EP2023/057763

§ 371 Date: Sep. 26, 2024

(30) Foreign Application Priority Data
Apr. 1, 2022 (EP) 22166326.3

(51) Int. Cl. H04B 10/69; H04B 10/58

(52) U.S. Cl. CPC H04B 10/695; H04B 10/58

(57) ABSTRACT

This invention relates to a receiver configured to exploit physical phenomena of a memory in an electro-optical converter of an emitter (e.g., LED) at a transmitting end. The memory can be described as a state that is a function of an input signal of the emitter, while the emitted light is a function of the state. An incoming symbol bit sequence and corresponding state(s) of the electro-optical converter are estimated (e.g., in terms of time varying carrier concentration or charge in a quantum well) to derive a decision for a state of a received symbol. This estimation can be done for multiple levels of incoming data (e.g., at least for hypothesized binary values).

### FIELD OF THE INVENTION

The invention relates to the field of signal detection in optical communication networks, such as—but not limited to—LiFi networks, for use in various different applications for home, office, retail, hospitality and industry.

### BACKGROUND OF THE INVENTION

Optical wireless communication (OWC) systems, such as LiFi networks (named like WiFi networks), enable mobile user devices (called end points (EP) in the following) like laptops, tablets, smartphones or the like to connect wirelessly to the internet. WiFi achieves this using radio frequencies, whereas LiFi uses the light spectrum which can enable unprecedented data transfer speed and bandwidth. Furthermore, LiFi can be used in areas susceptible to electromagnetic interference.

Based on modulations, information conveyed by coded light can be detected using any suitable light sensor. This can be a dedicated photocell (point detector), an array of photocells possibly with a lens, reflector, diffuser of phosphor converter, or a camera comprising an array of photocells (pixels) and a lens for forming an image on the array. E.g., the light sensor may be a dedicated photocell included in a dongle which plugs into the end point, or the sensor may be a general purpose (visible or infrared light) camera of the end point or an infrared detector initially designed for instance for 3D face recognition. Either way this may enable an application running on the end point to derive data from received light.

As an example, on-off keying (OOK) is an attractive modulation method that is widely used in fiber-optic and OWC systems based on semiconductor transmitters or emitters (such as laser diodes or light emitting diodes (LEDs)) due to the high throughput that can be achieved by a two-level modulation. The use of multilevel signals (e.g., pulse amplitude modulation (PAM)) demands M=2m signal levels to transfer M bits and all these levels must be separated by some minimum distance to make the signals robust against noise. Hence, it is most energy effective to avoid the use of multiple bits per symbol. However, the use of only two bits per symbol is more demanding in terms of signal bandwidth.

Orthogonal Frequency Division Multiplexing (OFDM) is a popular modulation method that can cope with the bandwidth limitations imposed by the optical emitter. In fact, most LEDs do not have a hard bandwidth limitation, but it rather acts as a gentle (e.g., first-order) low-pass filter. OFDM can handle modulation above the LED 3 dB bandwidth. On the other hand, PAM has an advantage over OFDM of being simpler and having a better peak-to-average ratio, which is favorable for communication through non-negative intensity modulated LED channels.

Due to the physics of semiconductor light sources (such as LEDs or laser diodes), it takes a certain time to reach a steady-state low or high value of a binary driving signal. Laser diodes are faster but their rise and fall times can still be a limiting factor. If the bit rate is larger than e.g. two times the bandwidth of the semiconductor light source, inter-symbol interference (ISI) occurs.

As a solution to the self-interference problem it has been proposed to invert the channel characteristic by boosting the signal at higher frequencies. Such equalizers, also known as linear equalizers, have the disadvantage of boosting the noise. This is problematic for weak signals, but also in short-range channels with a relatively strong signal. In the latter case, use of higher bit rates is precluded, which a good signal-to-noise ratio (SNR) would otherwise allow.

Solutions based on pre-distortion or post-equalization have in common that their operation to insert a distortion involves a significant penalty of reducing SNR. In the post compensator, a noisy signal is inverted, because the input to the post-equalizer contains noise (i.e., post-equalization boosts the noise). Alternatively, a pre-distorter increases the variance of the signal. This must be compensated by reducing the signal strength that can be handled. So, again, the SNR is deteriorated.

### SUMMARY OF THE INVENTION

It is an object of the present invention to provide an improved detection approach suitable for detecting radiation signals generated by semiconductor light sources.

This object is achieved by an apparatus as claimed in claim 1, by a receiver as claimed in claim 12, by an optical communication system as claimed in claim 13, by a method as claimed in claim 14, and by a computer program product as claimed in claim 15.

According to a first aspect, an apparatus is provided for deriving digital symbol information from a received optical signal, the apparatus comprising:
a symbol recovery unit for generating decision data about at least one binary state of a symbol detected in a temporal window of the received optical signal; and
a reconstructing feedback unit for using an emitter state model to model based on the decision data a junction state of a semiconductor light source that has generated the received optical signal and for feeding back a symbol reconstruction information to the symbol recovery unit to obtain the digital symbol information.

According to a second aspect, a method of deriving digital symbol information from a received optical signal is provided, the method comprising:
generating decision data about at least one binary state of a symbol detected in a temporal window of the received optical signal; and
modelling based on the decision data a junction state of a semiconductor light source that has generated the received optical signal and for feeding back a symbol reconstruction information to obtain the digital symbol information.

Accordingly, a model-based detection scheme is proposed, that is configured to estimate a received data bit or level but also a corresponding state of an electro-optical convertor used at the transmitting end. In particular, if the electro-optical convertor is an LED, the receiver may estimate the state in terms of a time varying (electron and/or hole) carrier concentration, or equivalently a charge in the quantum well. The receiver may perform this estimation for multiple possible values or levels of the incoming data (e.g., at least for a hypothesized lower binary value (e.g., “0” or “−1”) and/or higher binary value (e.g., “1” or “+1”).

The underlying idea is that an electro-optical convertor in a semiconductor emitter (e.g., an LED, laser diode or the like) has a memory effect, comparable with a capacitance with a non-linear load. This memory effect can be described as a state which is a function of the input signal, i.e., where the “capacitance” is charged/discharged by the current that drives the emitter. The generated output light is a function of this state rather than the instantaneous input signal. Thus, the driving signal supplied to the emitter creates an output light signal that can be detected at a receiver and used to estimate a transmitted data sequence modulated on the output light signal, while the memory effect of the emitter may cause inter-symbol interference and thus deteriorate the ability of the receiver to recover the transmitted data sequence. Thus, a feedback scheme for detection can be provided, in which a model of an electro-optical converter (e.g., LED) at the transmitting end is copied or estimated. On the receiver side, in the absence of the actual inputs to the emitter, the received and reconstructed digital symbol information is used to determine the state. The state of reconstruction/feedback thus resembles what happens inside a junction (memory effect) of the electro-optical converter. Thereby, the feedback model used for detection can be simplified to a few coefficients, which facilitates the estimation.

The proposed model of the electro-optical converter allows implementation of an infinite impulse response (IIR) operation because the effect of a symbol error is sufficiently suppressed or dampened, particularly if time progresses.

It is noted that the proposed detection scheme also works well for transmission over optical fibers (e.g. polymer optical fibers (POFs)) which allow small and thus fast detectors. Thereby, higher bit rates can be achieved for semiconductor light sources (e.g. LEDs) over optical fibers as well.

According to a third aspect, a receiver is provided, which comprises an apparatus according to the first aspect and a photo detector for receiving the optical signal.

According to a fourth aspect, an optical communication system comprising a receiver according to the third aspect and a transmitter with a modulator and light source for generating the optical signal.

According to a fifth aspect, a computer program product is provided, which comprises code means for producing the steps of the above method of the second aspect when run on a processor device.

According to a first option of any of the first to fifth aspects, the emitter state model may be a model of a junction of an electro-optical converter, that models the charge state of the junction, including a memory effect of the electro-optical converter, during electro-optical conversion, wherein the emitter state model is configured to provide inter-symbol interference, ISI, prediction for current and future symbols, and wherein a corresponding component is subtracted from the received light signal to suppress ISI in the received optical signal for a subsequent data symbol. Thereby, inter-symbol interference can be reliably estimated based on the memory effect of the light source to improve detection accuracy.

According to a second option of any of the first to fifth aspects, which can be combined with the first option, the emitter state model may be used to estimate the state in terms of a time varying carrier concentration or charge in a quantum well for multiple possible symbol values or levels of the received optical signal. Thus, effects of carrier concentration or charge accumulation can be used for better estimation of state changes caused by successive symbol values or levels of the received optical system.

According to a third option of any of the first to fifth aspects, which can be combined with the first or second option, an infinite impulse response feedback operation is provided. Thus, the applied emitter state model provides sufficient dampening to allow an infinite number of feedback cycles for optimized estimation results.

According to a fourth option of any of the first to fifth aspects, which can be combined with any one of the first to third options, the emitter state model may be dependent on a plurality of parameters and variables, wherein the variables may be updated for every sample and the parameters may be set for the model based on the type of the light source and/or for aging considerations. Thereby, a flexible emitter state model is provided, which can be adapted to various different light sources.

In situations where transmitters and receivers pairs are developed and manufactured so as to communicate with one another, the emitter state model may be established a priori and the emitter state model parameters and variables may be preconfigured.

Alternatively, when the emitter state model is standardized between devices, transmitters may be characterized and the parameters and variables may be shared by the transmitter with the receiver. This may be done as part of the setup of a communication link between transmitter and receiver, or alternatively when not part of the communication protocol, may be shared on a higher protocol layer (e.g. application layer). In order to enable such operation, a receiver preferably starts communication using a preconfigured emitter state model that at least enables low-speed communication between the transmitter and receiver. Then as part of the communication protocol, or as part of the payload packages of the communication protocol, model parameters and variables of the transmitter may be shared with the receiver to allow the receiver to further improve the quality of the emitter state model prediction at the receiver side.

More alternatively still, the transmitter and receiver may, as part of their communication setup proceed through a number of test-sequences, that allows the receiver to learn the transmitter state model, by means of known—a priori—agreed test sequences, that allow the receiver to establish the parameters and/or variables of the emitter state model. In case a receiver interacts with various transmitters with different emitter state models, it may be possible to characterize the individual transmitters, and associate a transmitter identity, such as their MAC address, with the emitter state model parameters/variables. To speed up operation, a receiver may contain a cache for storing emitter state model parameters and variables, of devices that it may have recently communicated with, such that when a receiver receives messages from a known transmitter, it is possible to select the appropriate parameters.

According to a fifth option of any of the first to fifth aspects, which can be combined with any one of the first to fourth options, the symbol recovery unit may comprise a decision engine configured to feed back symbol decisions to an updating circuit that is configured to update at least one variable and metric for the emitter state model based on the received symbol decisions and to supply the updated at least one variable and metric to a model instantiation circuit configured to mimic a response of the light source, wherein each symbol of sequential digital output values of the received optical signal may be supplied to a plurality of distance calculator circuits or correlators configured to calculate a value of distance or respectively likelihood with respect to respective model instantiation values output from the model instantiation circuit, and wherein the calculated distances or respectively likelihoods may be supplied to the decision engine where they are used to provide an equalized output value of each symbol. Thus, a straightforward distance or likelihood-based solution can be provided, where successive symbol values can be corrected on the fly based on estimated memory effects of the light source as reflected by the emitter state model.

According to a sixth option of any of the first to fifth aspects, which can be combined with any one of the first to fifth options, the received optical signal may be modulated by an on-off keying modulation, wherein model instantiations of the model instantiation circuit may be implemented by a first register for storing a hypothesis that an incoming symbol comprises a first binary value and a second register for storing a hypothesis that the incoming symbol comprises a second binary value, wherein the first and second registers may both be updated for every sample of the received optical signal, and wherein register values of the first and second registers may be sampled and compared in the distance calculators or correlators at the end of a symbol reception period. Thereby, a simple register-based solution can be provided for on-off keying or other two-state modulation types.

According to a seventh option of any of the first to fifth aspects, which can be combined with any one of the first to sixth options, the model instantiation circuit may be configured to track the state of the light source for a number of possible previous incoming symbols. Thus, effects of previous incoming symbols on the current state of the light source can be considered to improve estimation accuracy.

According to an eighth option of any of the first to fifth aspects, which can be combined with any one of the first to seventh options, the model instantiation circuit may be configured to track a progression of the state of the emitter state model at a higher time resolution than a symbol rate during reception of a symbol. Thereby, symbol reconstruction accuracy can be improved by providing intermediate state estimations during a symbol period.

According to a ninth option of any of the first to fifth aspects, which can be combined with any one of the first to eighth options, a largest likelihood metric may be calculated for a predetermined number of successive time instants in the temporal window based on a corresponding estimated bit value for a target time instant, a bit decision may be made based on an argument of the likelihood metric, and the estimated bit value may be updated according to the bit decision. Thus, accuracy of symbol reconstruction can be improved by using likelihood values of plural successive time instants.

According to a tenth option of any of the first to fifth aspects, which can be combined with any one of the first to ninth options, a further reconstruction feedback unit may be provided, that uses an alternative hypothesis for obtaining and feeding back a further symbol reconstruction information to the symbol recovery unit to be used together with the symbol reconstruction information to decide about the digital symbol information. Thereby, symbol reconstruction can be further improved by feeding back symbol reconstruction information derived from different hypotheses.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1, the receiver of claim 12, the optical communication system of claim 13, the method of claim 14, and the computer program product of claim 15 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically a block diagram of an optical communication system in which embodiments of the present invention can be implemented;

FIG. 2 shows schematically a block diagram of a model-based decision feedback approach according to an embodiment;

FIG. 3 shows schematically a block diagram of a receiver with a more detailed example of a model-based decision feedback structure according to an embodiment;

FIG. 4 shows schematically a decision-making scheme for an OOK detector;

FIG. 5 shows schematically a decision-making scheme for a detector with a memory depth of two symbols;

FIG. 6 shows a flow diagram of a procedure for deriving state estimates and likelihood values according to an embodiment; and

FIG. 7 shows schematically a block diagram of a model-based decision feedback approach with additional hypotheses testing according to an embodiment.

### DETAILED DESCRIPTION OF EMBODIMENTS

Various embodiments of the present invention are described in the following based on a LiFi system. Although the present invention is advantageous within the context of an illumination system, the invention is not limited thereto and may also be used in an optical communication system that is not integrated with an illumination system or in a fiber-based optical communication system.

Throughout the following, a light source may be understood as a radiation source that generates visible or non-visible light (i.e., including infrared (IR) or ultraviolet (UV)) light sources) for communication purposes. The light source may be included in a luminaire, such as a recessed or surface-mounted incandescent, fluorescent or other electric-discharge luminaires. Luminaires can also be of the non-traditional type, such as fiber optics with the light source at one location and the fiber core or “light pipe” at another. The concepts can also be used in peer-to-peer communication between smartphones or Internet of Things (IoT) devices.

It is further noted that when using optical wireless communication based on invisible parts of the light spectrum, such as infrared and/or ultraviolet, the system can be fully decoupled from any illumination systems. In such scenarios the optical wireless communications systems may function to primarily provide communication and a separate transceiver node may be used in the optical wireless communication system. Alternatively, such optical wireless communication systems may be complementary to a further function and thus be integrated in other application devices that benefit from such communication functionality; such as personal computers, personal digital assistants, tablet computers, mobile phones, televisions, etc.

Conventional light source luminaires are rapidly being replaced by light emitting diode (LED) or laser-based lighting solutions. In LiFi systems, more advanced LED or laser-based luminaires are enabled to act as LiFi communications hub to add LiFi connectivity to lighting infrastructure. The underlying idea is that an illumination infrastructure is positioned in such a manner that it provides a line of sight from the luminaire to locations where people tend to reside. As a result, the illumination infrastructure is also well positioned to provide optical wireless communication that likewise requires line of sight.

According to various embodiments, a detector at the receiving end of an optical communication link exploits the idea that a physical behavior (e.g., due to an internal junction between different semiconductor areas) of an electro-optical convertor of an emitter (e.g., a LED or laser diode or other semiconductor light emitting element) includes a memory effect. This memory effect can be described as a state which is a function of the input signal of the emitter (e.g., the drive current that is supplied to the emitter. The output light is then a function of this state. The memory effect(s) of the emitter can thereby deteriorate the ability of the receiver to recover the signal.

Contrary to a radio system with linear antenna(s), an electro-optical converter (e.g., an LED and in reasonable approximation also a laser) acts as a capacitance with a non-linear load. The driving current charges or discharges this capacitance. The recombination of electrons and holes depends on the carrier concentration, but in a non-linear manner (e.g., on its square, its cube or on even higher powers).

However, such a non-linear optical phenomenon can be modeled and therefore predicted. This concept is used in the proposed receiver to track the state of the emitter and use this to suppress inter-symbol interference resulting from the emitter model.

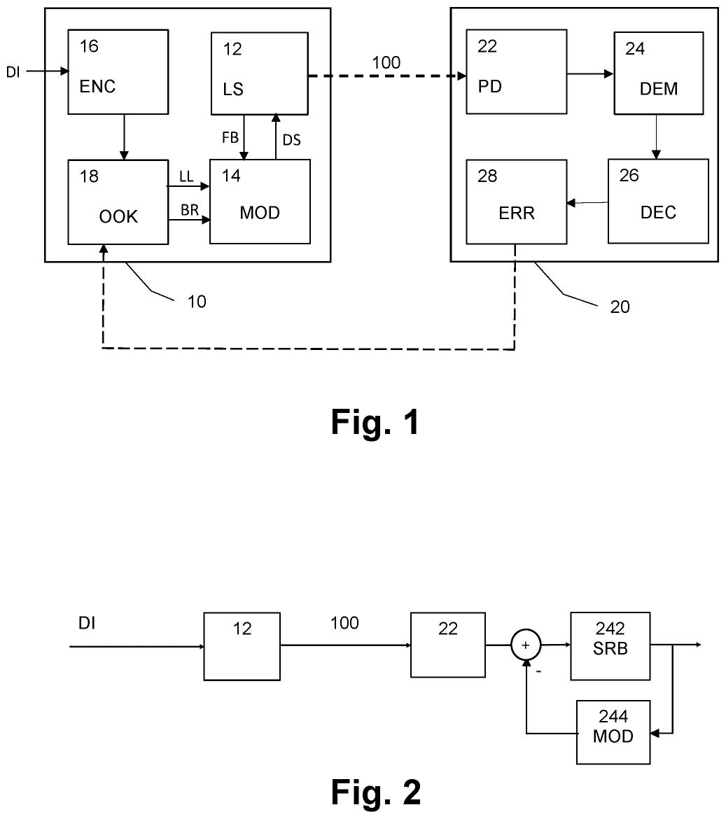

FIG. 1 shows schematically a block diagram of an optical communication system in which various embodiments of the proposed detection scheme can be implemented.

It is noted that—throughout the present disclosure—only those structural elements and functions are shown, which are useful to understand the embodiments. Other structural elements and functions are omitted for brevity reasons. Furthermore, components that are designated by same reference numbers in the drawings are intended to have same or similar structures and functions and may therefore be described only once for reasons of brevity.

The optical communication system of FIG. 1 may correspond to a communication link of a LiFi network comprises a transmitter (optical emitter) 10 (e.g., an access point (AP) with a luminaire of a lighting system) connected via an optical channel (e.g., an optical free-space link) to a receiver (light detector) 20. A respective light output 100 (e.g., light beam) generated by a light source (LS) 12 of the transmitter 10 is received by a photo detector (PD) 22 of the receiver 20. The light source 12 may comprise a radiation emitting element (e.g., LED or laser diode or other semiconductor electro-optical converter) and the photo detector 22 may comprise a radiation detecting element.

Additionally, the transmitter 10 comprises an encoder (ENC) 16 for encoding input data DI received via an interface circuit (not shown) to obtain a binary data sequence which consists of a sequence of binary values (e.g., “0” and “1” or “−1” and “+1”) of one-bit or multi-bit symbols according to a selected binary encoding scheme. The binary data sequence is supplied to an OOK controller (OOK) 18 which controls the modulator circuit (e.g., switching circuit) 14 to generate a driving signal DS (e.g., driving current or voltage) in accordance with a driving scheme and supply it to the light source 12 to generate the light output 100 with OOK or other keying-based modulation scheme.

Throughout the following disclosure the term “symbol” is intended to cover a single-bit information or multi-bit information depending on the kind of modulation and/or encoding used in the (point-to-point) transmission system.

Moreover, the light source 12 may be configured to provide a feedback signal FB that indicates the light output level or a property or parameter related to light level to the modulator circuit 14, which uses the feedback signal FB together with the switching time/rate and/or maximum/minimum light level or light range to generate or control the driving signal DS and apply it to the light source 12.

In an example, the modulator circuit 14 (i.e., modulator driver) may act as a switching device that is controlled by the driving signal DS to switch the driving current through (or voltage across) the light source 12 (e.g., an optical emitter) between a number of discrete values (e.g., 2 or 4 discrete values).

At the receiver 20, the output signal of the photo detector 22 may be supplied to a demodulator (DEM) 24 where it is demodulated by detecting or discriminating light output levels to obtain a binary data sequence. This binary data sequency may then be decoded in a decoder circuit (DEC) 26 to obtain output data which should correspond to the original input data (i.e., original binary data sequence) DI supplied the transmitter 10. Then, an error detection circuit (ERR) 28 may check the output data based on an error detection scheme (e.g., parity checking, cyclic redundancy check (CRC), error correction coding etc.) to determine a transmission quality (e.g., SNR) of the optical transmission. The checking result may optionally be fed back from the receiver 20 to the transmitter 10 via an optical or other wireless channel as the transmission quality information used by the OOK controller 18.

In an example, a control software may be running on a central processing unit (CPU) of the receiver 20 to provide the proposed model-based detection functions discussed herein.

Being a semiconductor device (e.g., LED or laser), the physical properties of the light source 12 modify the optical output 100 to become a lowpass filtered version of the driving current. More specifically, a semiconductor junction provided in the light source 12 is a capacitance and discharging of that capacitance by means of hole-electron pairs that recombine into photons is a nonlinear function of the charge. Particularly, when the capacitance is in a state of low charge, not many photons are created such that discharging gets slower and slower. If the symbol rate or bit rate (BR) of the driving signal DS gets faster than the 3 dB bandwidth of the light source 12, then ISI would occur if no counter measures were applied.

In prior art, several approaches are already known to improve this by compensating nonlinearities of electro-optical conversion in the light source 12. As a first example, a post-compensation (post-equalizer) may be used to invert at the receiver 20 artefacts generated by the light source 12. As a second example, a pre-distortion (pre-distorter) may be provided to invert the artefacts at the transmitter 10 already.

These known measures have in common that the insertion of distortions is accompanied by the significant penalty of reducing signal quality (e.g., SNR, error rate, etc.) at the receiver 20. In the post-equalizer, a noisy signal is inverted, because the input to the post equalizer contains noise. The post-equalizer thus boosts the noise. Alternatively, the pre-distorter increases the variance of signal. This must be compensated by reducing the signal strength that can be handled. Thus, signal quality (e.g., SNR, error rate, etc.) is deteriorated here as well.

According to various embodiments, the proposed receiver 20 is configured to estimate a received sequence of binary or multi-level values, but also a corresponding state of the electro-optical convertor at the light source 12 at the transmitting end. In particular, the receiver 20 (e.g., the demodulator 24) may estimate the state in terms of a time varying carrier (electron, holes) concentration or equivalently a charge in a quantum well.

The classic model of a quantum well is to confine particles, which were initially free to move in three dimensions, to two dimensions, by forcing them to occupy a planar region. The effects of quantum confinement take place when the quantum well thickness becomes comparable to the de Broglie wavelength of the carriers (generally electrons and holes), leading to energy levels called “energy subbands”, i.e., the carriers can only have discrete energy values. Within the quantum well, there are discrete energy eigenstates that carriers can have. For example, an electron in the conduction band can have lower energy within the well than it could have in another region of the semiconductor structure. Consequently, an electron in the conduction band with low energy can be trapped within the quantum well. Similarly, holes in the valence band can also be trapped in the top of potential wells created in the valence band. The states that confined carriers can be in are particle-in-a-box-like states.

These state estimations can be performed for multiple possibilities (e.g., hypothesized binary states or value levels) of the incoming data.

FIG. 2 shows schematically a block diagram of a model-based decision feedback approach according to an embodiment.

The above-mentioned quality problems (SNR deterioration, noise enhancements, etc.) can be avoided by using a decision feedback equalizer. At the receiver 20 (e.g., the demodulator 24), a hard decision can be made. If the error probability of this decision remains acceptable, the received signal can be reconstructed without noise. Thus, it is also possible to predict exactly (noise free) what the ISI of future data bits or symbols will be. This ISI prediction can be used to subtract a corresponding component from the received light signal to clean up the light signal for the next data symbol.

As indicated in FIG. 2, interference added to the input data (DI) by the semiconductor light source 12 can be resolved by a decision feedback equalizer (DFE) 240 at the receiver 20 (e.g., demodulator 24) after detection of the optical output 100 by the photo detector 22, where a weighted sum of a past decision is fed back to cancel interference (e.g., ISI) generated in the present signaling interval (e.g., period between subsequent data bits or symbols). The number of past decisions used in the feedback equalization can be finite or infinite. Here, the DFE 240 is a non-linear equalizer, because it makes decisions on the symbols, which is a non-linear operation.

In the embodiment, the DFE 240 comprises a (non-linear) symbol recovery block (SRB) 242 in a forward branch and a (non-linear) model-based reconstruction block (MOD) 244 in a feedback branch. The reconstruction is based on a (state) model of the light source 12 (e.g., LED) and the output of the reconstruction block 244 is subtracted from the input signal of the symbol recovery block 242.

Thereby, an ISI prediction can be subtracted from the detected input signal to clean up the signal for the next data symbol. The ISI prediction can be based on a hard decision and if this hard decision is (sufficiently) error free, the received signal can be reconstructed without any ISI noise. The reconstruction model can be configured to provide ISI prediction for current and future data bits or symbols. The state of the reconstruction model and resulting reconstruction feedback of the reconstruction block 244 resembles what happens inside the light source 12 (e.g., LED junction) during electro-optical conversion.

The DFE 240 is thus a non-linear equalizer, because hard decisions of the data (non-linearly quantized into bits or symbols to cut out the ISI noise) are fed back into the demodulation circuit.

In embodiments, a very specific feedback scheme is implemented, that is copy of the model of the electro-optical conversion in the light source 12. The feedback model (e.g., copy of the electro-optical conversion model) may be simplified to a few coefficients to facilitate the ISI estimation. In an example, a squaring operation may be applied in the feedback model.

In view of the fact that the feedback model can be configured to ensure that the effect of one symbol/bit error dies out soon, an infinite impulse response (IIR) approach can be applied in the DFE 240.

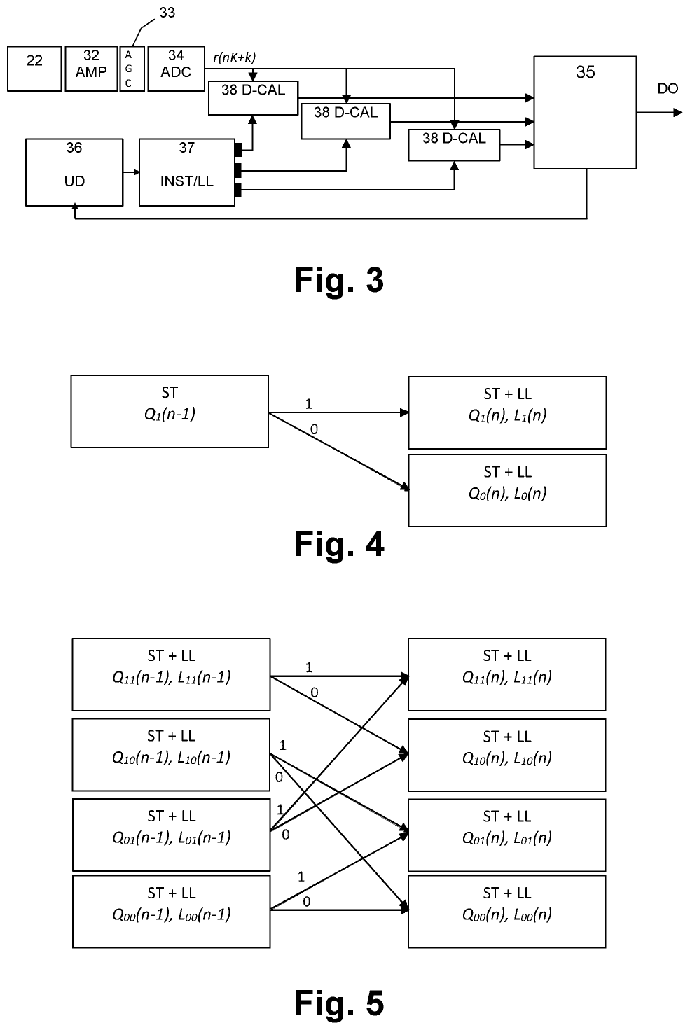

FIG. 3 shows schematically a block diagram of a receiver (e.g., the receiver 20 of FIG. 1) with a more detailed example of a model-based decision feedback structure according to an embodiment.

A photo detector (e.g., photo diode) 22 receives an optical signal from the transmission end (e.g., transmitter 10 in FIG. 1) and the detected signal is supplied e.g. to a transimpedance amplifier (AMP) 32 which is a current to voltage converter, often implemented with one or more operational amplifiers. The transimpedance amplifier is used to amplify a low-level current output of the photo detector 22 to a usable voltage. Current-to-voltage converters are used with sensors that have a current response that is more linear than the voltage response. This is the case with photo detectors (e.g., photo diodes) where it is not uncommon for the current response to have better than 1% nonlinearity over a wide range of light input. The transimpedance amplifier 32 presents a low impedance to the photo detector 22 and isolates it from the output voltage of an operational amplifier. In its simplest form, the transimpedance amplifier 32 has just a large-valued feedback resistor. The gain of the transimpedance amplifier can be set by this feedback resistor.

The amplified and current-to-voltage converted signal may then be supplied to an automatic gain control (AGC) circuit 33 which may be a closed-loop-feedback regulating circuit in an amplifier or chain of amplifiers with a purpose of maintaining a suitable signal amplitude at its output, despite variations of the signal amplitude at its input. The average or peak output signal level is used to dynamically adjust the gain of the amplifiers, enabling the circuit to work satisfactorily with a greater range of input signal levels. It is thus used to equalize the average signal quality due to differences in received signal strength.

The converted and gain-controlled signal is then supplied to an analog-to-digital converter (ADC) 34 which converts the received analog signal into a digital output representing the magnitude of the voltage or current. The digital output may be a two's complement binary number or any other binary or multi-level value.

The feedback structure of this embodiment is specific for the LED (or laser), as it contains a model for its electro-optical conversion operation.

In the example of FIG. 3, each symbol of sequential digital output values is supplied to three distance calculator circuits (D-CAL) 38 configured to calculate a value of distance (or likelihood) with respect to three model instantiation values output from a model instantiation/likelihood (INST/LL) circuit 37. The calculated distances (or likelihoods) are supplied to a decision engine (DE) 35 where they are used to provide an equalized output value (DO) of the DFE.

Furthermore, the decision engine 35 feeds back symbol decisions to an updating circuit (UD) 36 which is configured to update variable and metrics based on the received symbol decisions fed back from the decision engine 35. These updated variables and metrics are supplied to the model instantiation/likelihood circuit 37 which mimics the LED response, in particular, estimates the “state” trajectory of the LED. There are multiple possible model instantiations because during evaluation of incoming symbol samples it is not yet known which symbol was actually transmitted.

Each model instantiation evaluates the state for a possible incoming symbol, or in a more advanced form, tracks the state not only for the currently incoming symbol but also for possible values for a number of previous symbols or bits.

The model state value is an additional “variable” that can be tracked in a Viterbi-like decoder. This state value can have values out of a set that is larger than the state space. In an example, the model instantiation/likelihood circuit 37 may estimate the concentration of carriers (electrons/holes) in a junction of the LED light source, as this is a good description of the state that (fully or to a very large extent) determines the behavior of the light source. To this end, the progression of this state may be tracked, possibly at a higher time resolution than the symbol time (symbol rate or bit rate), i.e., oversampling may be performed.

Furthermore, in an example, a limited, discrete number of possible recent states may be considered.

In the following, a K-times oversampled system is assumed for prediction of a more accurate progression of the state during the reception of a digital symbol. Thus, one symbol lasts for K sample times, where the oversampling ratio K is a natural (integer) system constant larger than one. A non-oversampled system thus has K=1. The progression of time can be denoted as discrete steps, where the n-th symbol ends at nK and the (n+1)-th new symbol starts at (K n)+1, thus the first symbol (n=1) starts at time 1 and ends a time K. Thus, at the output of the ADC 34, discrete time signals r(nK+k) are obtained, where k is an integer value ranging from 1 to K and n denotes symbol number.

A new state s(nK+k) can be obtained from the previous states via the following equation:

$$s ( {k}^{′} ) = {a}_{0} I ( {k}^{′} ) + {a}_{1} s ( {k}^{′} - 1 ) + {a}_{2} {s}^{2} ( {k}^{′} - 1 ) + {a}_{3} {s}^{3} ( {k}^{′} - 1 )$$

where, in this expression, the time index k′ is any integer value, thus in any symbol interval, in particular we use k′ as shorthand for k\hat{ }′=nK+k. Examples of the values of the parameters a0 to a3 are described e.g. in J.-P. M. G. Linnartz, X. Deng, A. Alexeev and P. van Voorthuisen, “An LED Communication Model Based on Carrier Recombination in the Quantum Well,” 2021 IEEE 32nd Annual International Symposium on Personal, Indoor and Mobile Radio Communications (PIMRC), 2021, pp. 1-6, doi: 10.1109/PIMRC50174.2021.9569261. or more in tutorial style in J.-P. M. G. Linnartz, X. Deng, A. Alexeev and S. Mardanikorani, “Wireless Communication over an LED Channel,” in IEEE Communications Magazine, vol. 58, no. 12, pp. 77-82, December 2020, doi: 10.1109/MCOM.001.2000138.

Here, the LED input current I(k′) is not only a function of time but also a function of the transmitted symbol m, and can also be subject to filtering, e.g. a pre-emphasis in the digital or analog electronics at the modulator of the transmitter. Thus, I(k′) may be a filtered version (with memory) of the modulation symbol waveform.

In the present expressions, the state of the model is simplified as a single value and the light output as a memory-less function of this single value. Light sources may have a state space that is more dimensional. In such a case, the variable s( ) may be a vector. As an example, not only the concentration in the quantum well but also the concentration in a space charge region (SCR) may be considered to jointly describe the state, i.e.:

$$s ( {k}^{′} ) = [ {s}_{QW} ( {k}^{′} ) ; {s}_{SCR} ( {k}^{′} ) ]$$

Similarly, some state aspects of the electronics that drive the LED and may contribute to inter-symbol interference, such as energy temporarily stored in parasitic inductances in the LED wiring can be included in the model.

The receiver may track estimations of the state, which may depend on an assumption (i.e., a hypothesis) of the incoming symbol. Then, ŝᵢ(nK+k) denotes the i-the hypothesis for the state trajectory during sample k following after the start of the symbol transmission. In the following, the notation ŝᵢ is used to explicitly describe that the variable s is an estimate.

The light output as a function of the state s(k) can be expressed as follows:

$$Φ ( s ( {k}^{′} ) ) = {a}_{4} s ( {k}^{′} ) + {a}_{5} {s}^{2} ( {k}^{′} )$$

In the above example, a memory-less function is assumed. If a memory is provided, the state space needs to be increased.

The applied model is thus dependent on parameters and variables s, wherein the variables s may be updated for every sample. An example may be the state variable, e.g., carrier concentration. The parameters a describe the model and can be considered fairly constant. However, the parameters a may differ from one light source (e.g., LED) to another and may age over time. The channel attenuation is an example of a parameter that may need to be tracked, even if predetermined values are chosen for a specific type of light source.

In an example, the receiver may be configured to estimate the model parameters a0 to a5, or to obtain these from the transmitter.

The embodiment of FIG. 3 is now described on the basis of a detector algorithm for an OOK modulated light output.

In an example, model instantiations of the model instantiation/likelihood circuit 37 may be implemented by two registers, i.e., a first register Q0 for the hypothesis that the incoming bit is a first binary value (e.g., zero) and a second register Q1 for the hypothesis that the incoming bit is a second binary value (e.g., one). Both registers Q0 and Q1 are updated for every input sample r(nK+k). The register values are sampled and compared in the distance calculators 38 at the end of a symbol reception.

These registers thus contain the state:

$${Q}_{m} = ( nK + k ) .$$

According to an exemplary model described in Linnartz et al: IEEE Com Mag December 2020, a new state s(nK+k) can be obtained from previous states by using the following equation:

$${\hat{s}}_{m} ( nK + k ) = {a}_{0} {I}_{m} ( k ) + {a}_{1} {\hat{s}}_{m} ( nK + k - 1 ) + {a}_{2} {\hat{s}}_{m}^{2} ( nK + k - 1 ) + {a}_{3} {\hat{s}}_{m}^{3} ( nK + k - 1 )$$

where ŝₘ( ) denotes an estimated state value under the hypothesis that the current incoming symbol has value m (m=0 or 1), and Iₘ( ) denotes the current that corresponds to symbol value m.

Since Iₘ is the LED input current for the hypothesized symbol, a reference may be stored that is identical for all symbols n. For instance, for typical non-pre-emphasized OOK, I₀(k)=0 and I₁(k)=350 mA may be stored for all sample times k.

The register state can be expressed as follows in pseudo-code for each symbol: repeat K times, thus for k=1 to K

$${Q}_{m} := {a}_{0} {I}_{m} + {a}_{1} {Q}_{m} + {a}_{2} {Q}_{m}^{2} + {a}_{3} {Q}_{m}^{3}$$

The receiver may thus make a decision on a previous incoming n-th symbol at time nK, then it updates its estimate of the state of the LED light source s(Kn).

Additionally, the receiver calculates and updates the distance or the likelihood. The distance dₘ( ) between the incoming symbol r(nK+k) and the hypothesized output of the model instantiation/likelihood circuit 37 (subject to symbol being of value m) can be expressed by the following equation:

$${d}_{m}^{2} = {\sum }_{k = 1}^{K} {[ {h}^{- 1} r ( nK + k ) - Φ ( {s}_{m} ( nK + k ) ) ]}^{2}$$

Thus, the incoming sample r(nK+k) is normalized by the distance calculators 38 to correct for channel attenuation h and calculate the difference with the hypothesized light output, assuming a symbol value m (0 or 1). This difference or distance can be interpreted as a measure of the noise, so that it can be assumed by the decision engine 35 that the most likely symbol is the one for which that calculated difference (i.e., output of the distance calculators 38) is the smallest.

In an example, the receiver (e.g., decision engine 35) may store the distances in registers L₀ and L₁. Both registers are reset at the beginning of the symbol interval, and updated for k=1 to K according to the following equation:

$${L}_{m} = {[ {h}^{- 1} r ( nK + k ) - Φ ( {s}_{m} ( nK + k ) ) ]}^{2}$$

The light output Φ(sₘ(nK+k)) is in fact an estimate that is based on a previous decision on incoming bits. These previous decisions are fed back via the update and model instantiation circuits 36, 37 and subtracted by the decision calculators 38 from newly incoming symbols. These feedback-and-subtract samples are subject to at least two hypothesized values of the new symbol state m.

In an alternative example, a correlator may be used to calculate M correlations and correct with a threshold T. In particular for OOK, with M=2, the expectation values of the state trajectories can be calculated as follows:

$${\hat{s}}_{0} ( nK + k ) = Es ( nK + k \vert \hat{s} ( nK ) , m = 0 ) ; and \\ {\hat{s}}_{m} ( k ) = Es ( nK + k \vert \hat{s} ( nK ) , m = 1 )$$

can be calculated.

The distance may also be calculated in an alternative way by considering that h⁻²r²(nK+k) is dependent on the symbol state m and not discriminating for the best choice. It can thus be removed. Instead, decisions at the decision engine 35 can be based on the following equation:

$$- 2 {\sum }_{k = I}^{K} {r}^{2} ( n K + k ) Φ ( {s}_{m} ( n K + k ) ) + {h}^{2} {\sum }_{k = 1}^{K} {Φ}^{2} ( {s}_{m} ( n K + k ) )$$

Here the first sum of the term is a correlation Cm and the second sum of terms is a correction for different energy Eₘ in different symbols and does not depend on the incoming samples r( ).

A binary symbol value “1” is decided if ζ<0, thus if the binary symbol “1” has the lowest distance, with

$$ζ = {C}_{1} - {C}_{0} + {h}^{2} [ {E}_{1} - {E}_{0} ]$$

Thus, E₁-E₀ can be seen as a threshold which shifts, depending on the state at the beginning of the bit interval.

Secondly, C₁-C₀ is the difference of a correlation. It can be rewritten as the correlation of the incoming symbol with the difference of the hypothesized trajectories, as expressed by the following equation:

$$- 2 {\sum }_{k = 1}^{K} r ( nK + k ) [ Φ ( {s}_{1} ( nK + k ) ) - Φ ( {s}_{0} ( nK + k ) ) ]$$

which provides a simpler implementation for OOK modulation.

E.g., a look-up table can be created for a sufficiently large number of state values. These represent the estimated state at the start of the bit interval. For each state value, correlation weight-factor values are stored, that can be calculated as follows:

$$[ Φ ( {s}_{1} ( nK + k ) ) - Φ ( {s}_{0} ( nK + k ) ) ]$$

Furthermore, a threshold value is stored that can be calculated as follows:

$${\sum }_{k = 1}^{K} {Φ}^{2} ( {s}_{1} ( nK + k ) ) - {Φ}^{2} ( {s}_{0} ( nK + k ) )$$

The automatic gain control circuit 33 can be configured to correct the incoming signals for the channel characteristic h.

Oversampling may not be needed. Anyhow, the calculated single value Σₖ₌₁^{K} [Φ²(s₁( ))−Φ²(s₀( ))] can be integrated into a threshold. The correlation by a time-dependent weight factor may be simplified and approximated. Typically, Φ(s₁(nK+k))−Φ(s₀(nK+k)) monotonously grows with k, where the samples near the symbol end k=K, weigh most heavily. In an example, approximation can be achieved by using a low-pass filter and using one sample slightly before the symbol end only:

$${C}_{1} - {C}_{0} = - 2 {\sum }_{k = 1}^{K} r ( nK + k ) Φ ( {s}_{1} ( nK + k ) ) \approx - 2 LPF \{ r ( ) \} Φ ( {s}_{1} ( ( n + 1 ) K - 1 ) )$$

With this approximation, the proposed system collapses into a “dynamic threshold” receiver. That is, during the detection of the bits, it tracks the state, and translates this state into a threshold via a look-up table.

In another example, the distance to a hypothesized symbol 1 and 0 can also be calculated and used in a soft decision decoder.

FIG. 4 shows schematically a decision-making scheme for a decision engine in an OOK detector which uses two model instantiations.

In an OOK scheme, a symbol state Q₁(n−1) at symbol instant n−1 is tracked and a best-choice is made for the state. After symbol reception, a decision is made on the most likely symbol state (ST) Q₁(n) or Q₀(n) (i.e., either 0 or 1) based on the likelihood (LL) L₁(n) or L₀(n) of these symbol states. The state is then updated accordingly.

Otherwise, in a PAM scheme with multiple symbol levels (i.e., pulse amplitude values), the receiver generates M hypotheses (0 to M−1) based on a new estimate of the state s(nK), one for every possible PAM symbol level that the transmitter may be sending. For every hypothesis, the receiver calculates what the following state s(nK+k) and received K samples r(nK+k) with k=1 to K−1 would be if the channel were noise-free.

During the reception of the n-th symbol, the receiver correlates the received signal with the hypothetical signal that would be created under the M hypotheses to obtain respective likelihoods.

FIG. 5 shows schematically a decision-making scheme for a detector with memory depth of two symbols, in which a non-linear emitter state estimator and Viterbi decoder is used.

The memory depth of two symbols allows that the detector structure is cycled one step during every symbol reception.

For binary modulation, two paths are split out of each state, i.e., one path for a hypothesized next 1 and another path for a hypothesized next 0. Thus, there eight possible paths, starting from the total of four tracked states Q11(n−1), Q10(n−1), Q01(n−1) and Q00(n−1) of the two symbols and ending at states Q11(n), Q10(n), Q01(n) and Q00(n) with respective likelihoods L11(n), L10(n), L01(n) and L00(n).

The incoming bit value may be indicated by an index m0, and the previous bits by an index m−1 and m−2. So, for the register QQₘ_{_{−2}}_{,m}_{_{−1}}, two outgoing tracks are evaluated, which are denoted as Qₘ_{_{−2}}_{,m}_{_{−1}}_{,0} and Qₘ_{_{−2}}_{,m}_{_{−1}}_{,1}. During the reception of samples, the distance between these samples and the hypothesized states are calculated, separately for either a 0 or 1 arriving.

In pseudo-code, the following calculations are repeated K times, thus for k=1 to K, for the hypothetical state values and likelihoods of register Q_{b-2,b-1,b}:

$${Q}_{{m}_{- 2} , {m}_{- 1} , {m}_{0}} := {a}_{0} {I}_{n} + {a}_{1} {Q}_{{m}_{- 2} , {m}_{- 1} , {m}_{0}} + {a}_{2} {Q}_{{m}_{- 2} , {m}_{- 1} , {m}_{0}}^{2} + {a}_{3} {Q}_{{m}_{- 2} , {m}_{- 1} , {m}_{0}}^{3} \\ {L}_{{m}_{- 2} , {m}_{- 1} ,} = {[ {h}^{- 1} r ( nK + k ) - Φ ( {s}_{m} ( nK + k ) ) ]}^{2}$$

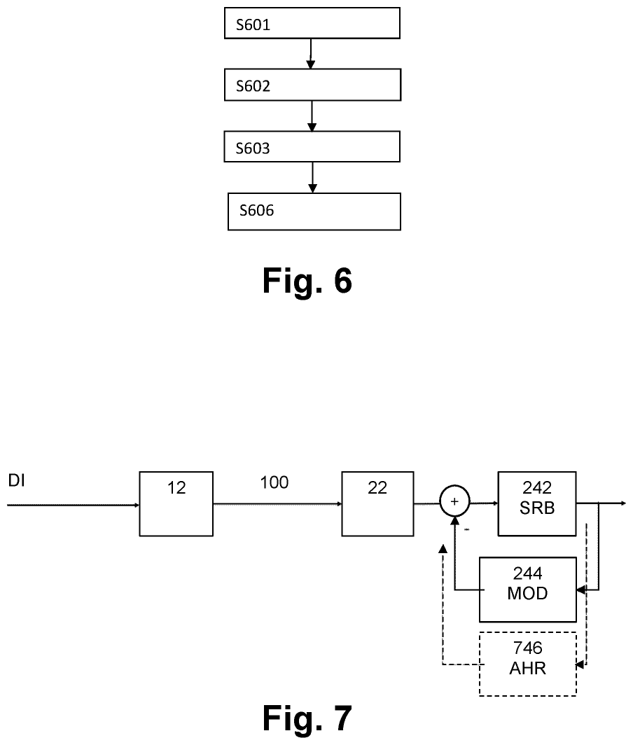

FIG. 6 shows a flow diagram of a procedure for deriving state estimate and likelihood values according to an embodiment with memory depth of two symbols.

At the completion of a reception of a symbol, the following steps are taken to create values for the state estimates Q11, Q10, Q01, Q00 and for the likelihoods L11, L10, L01, L00.

In step S601, a largest likelihood metric max (L111, L101, L011, L001, L110, L100, L010, L000) is calculated based on a corresponding bit value for time instant m−2, wherein the first index indicates the bit at time instant n−2, the second index indicates the bit at time instant n−1 and the third index indicates the bit at time instant n.

Then, in step S602, a bit decision is made for Qₘ₋₂, i.e., the bit at time instant n−2. This bit is decided based on the argument of the above likelihood metric. Thus, decide that Qₘ₋₂=1 if at least one of the values L111, L101, L111, L101 is the largest (if L denotes a likelihood), or the smallest (if L denotes distances), and Qₘ₋₂=0 if at least one of the values L011, L001, L011, L001 is the largest (if L denotes a likelihood), or the smallest (if L denotes distances).

Then, in step S603, the likelihood values are updated if the likelihoods are maintained (as an alternative, they may be reset to default values). Per metric register, the largest likelihood values of both incoming paths (or the smallest if L denotes distances) are selected as follows:
New L11 is max(L111, L011)
New L10 is max(L110, L010)
New L01 is max(L101, L001)
New L00 is max(L100, L000)

At some instances, all metrics may need to be reduced to avoid that these grow without bounds. For instance, a common value may be subtracted from all, if their values get too large.

In step S604, the estimates for the states are updated. The new state Qₘ_{_{−1}}_{,m}_{₀} is the state that corresponds to the largest likelihood path:

$${Q}_{{m}_{- 1} , {m}_{0}} := {Q}_{1 , {m}_{- 1} , {m}_{0}}$$

if the likelihood L_{1,m}_{_{−1}}_{,m}_{₀}>L_{0,m}_{_{−1}}_{,m}_{₀} (or equivalently if the distance is <) otherwise:

$${Q}_{{m}_{- 1} , {m}_{0}} := {Q}_{0 , {m}_{- 1} , {m}_{0}}$$

FIG. 7 shows schematically a block diagram of a model-based decision feedback approach with additional hypotheses testing according to an embodiment.

As indicated in FIG. 7, a further feedback branch via an additional reconstruction block (AHR) 746 that uses an alternative hypothesis is added. Such a further extension is directed to the idea of testing multiple hypotheses to avoid error propagation, similar to a Viterbi equalizer.

Thus, multiple hypotheses are used together with the light source model to perform the feedback decision for the symbol state. For instance, if the inter-symbol interference spreads over three symbols, but dies out after a fourth symbol, eight hypotheses can be checked, namely whether the previous bits were 000, 001, 010, 011, 100, 101, 110 or 111.

In an embodiment, the optical communication system may be provided with a transmitter that shares the parameter values of a0 to a5 of the light source to allow the receiver to receive and use these parameters for setting up the feedback model. Additionally, the transmitter may share information on a possible filtering of the current used for driving the light source.

To summarize, a receiver has been described, which is configured to exploit physical phenomena of a memory in an electro-optical converter of an emitter (e.g., LED) at a transmitting end. The memory can be described as a state that is a function of an input signal of the emitter, while the emitted light is a function of the state. An incoming symbol bit sequence and corresponding state(s) of the electro-optical converter are estimated (e.g., in terms of time varying carrier concentration or charge in a quantum well) to derive a decision for a state of a received symbol. This estimation can be done for multiple levels of incoming data (e.g., at least for hypothesized binary values).

While the invention has been illustrated and described in detail in the drawings and foregoing description, such illustration and description are to be considered illustrative or exemplary and not restrictive. The invention is not limited to the disclosed embodiments. The proposed model-based decision feedback concept can be applied to other types of optical wireless networks and with all types of access devices, modems and transceivers. In particular, the invention is not limited to LiFi-related environments, such as the ITU-T G.9961, ITU-T G.9960, and ITU-T G.9991 network environment. It can be used in visible light communication (VLC) systems, IR data transmission systems, G.vlc systems, OFDM-based systems, connected lighting systems, OWC systems, and smart lighting systems.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

A single unit or device may fulfill the functions of several items recited in the claims. The mere fact that certain measures are recited in mutually different dependent claims does not indicate that a combination of these measures cannot be used to advantage.

The described procedures like those indicated in FIG. 6 and the function of the blocks in FIGS. 1 to 3 and 7 can be implemented as program code means of a computer program and/or as dedicated hardware of the receiver devices or transceiver devices, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus for deriving digital symbol information from a received optical signal, the apparatus comprising:
a symbol recovery unit for generating decision data about at least one binary state of a symbol detected in a temporal window of the received optical signal; and
a reconstructing feedback unit for using an emitter state model to model based on the decision data a junction state of a semiconductor light source that has generated the received optical signal and for feeding back a symbol reconstruction information to the symbol recovery unit to obtain the digital symbol information.

2. The apparatus of claim 1, wherein the emitter state model is a model of a junction of an electro-optical converter, that models the charge state of the junction, including a memory effect of the electro-optical converter, during electro-optical conversion, wherein the emitter state model is configured to provide inter-symbol interference, ISI, prediction for current and future symbols, and wherein the apparatus is configured to subtract a corresponding component from the received light signal to suppress ISI in the received optical signal for a subsequent data symbol.

3. The apparatus of claim 2, wherein the emitter state model is used to estimate the state in terms of a time varying carrier concentration or charge in a quantum well for multiple possible symbol values or levels of the received optical signal.

4. The apparatus of claim 1, wherein the apparatus is configured to provide an infinite impulse response feedback operation.

5. The apparatus of claim 1, wherein the emitter state model is dependent on a plurality of parameters and variables, wherein the reconstructing feedback unit is configured to update the variables for every sample and to set the parameters for the model based on the type of the light source and/or for aging considerations.

6. The apparatus of claim 1, wherein the symbol recovery unit comprises a decision engine configured to feed back symbol decisions to an updating circuit that is configured to update at least one variable and metric for the emitter state model based on the received symbol decisions and to supply the updated at least one variable and metric to a model instantiation circuit configured to mimic a response of the light source, wherein each symbol of sequential digital output values of the received optical signal is supplied to a plurality of distance calculator circuits or correlators configured to calculate a value of distance or respectively likelihood with respect to respective model instantiation values output from the model instantiation circuit, and wherein the calculated distances or respectively likelihoods are supplied to the decision engine where they are used to provide an equalized output value of each symbol.

7. The apparatus of claim 6, wherein the received optical signal is modulated by an on-off keying modulation, wherein model instantiations of the model instantiation circuit are implemented by a first register for storing a hypothesis that an incoming symbol comprises a first binary value and a second register for storing a hypothesis that the incoming symbol comprises a second binary value, wherein the first and second registers are both updated for every sample of the received optical signal, and wherein register values of the first and second registers are sampled and compared in the distance calculators or correlators at the end of a symbol reception period.

8. The apparatus of claim 7, wherein the model instantiation circuit is configured to track the state of the light source for a number of possible previous incoming symbols.

9. The apparatus of claim 6, wherein the model instantiation circuit is configured to track a progression of the state of the emitter state model at a higher time resolution than a symbol rate during reception of a symbol.

10. The apparatus of claim 6, wherein the apparatus is configured to calculate a largest likelihood metric for a predetermined number of successive time instants in the temporal window based on a corresponding estimated bit value for a target time instant, to make a bit decision based on an argument of the likelihood metric, and to update the estimated bit value according to the bit decision.

11. The apparatus of claim 1, further comprising a further reconstruction feedback unit that uses an alternative hypothesis for obtaining and feeding back a further symbol reconstruction information to the symbol recovery unit to be used together with the symbol reconstruction information to decide about the digital symbol information.

12. A receiver comprising the apparatus as claimed in claim 1 and a photo detector for receiving the optical signal.

13. An optical communication system comprising the receiver as claimed in claim 12 and a transmitter with a modulator and light source for generating the optical signal.

14. A method of deriving digital symbol information from a received optical signal, the method comprising:
generating decision data about at least one binary state of a symbol detected in a temporal window of the received optical signal; and
modelling based on the decision data a junction state of a semiconductor light source that has generated the received optical signal and for feeding back a symbol reconstruction information to obtain the digital symbol information.

15. A non-transitory computer readable medium comprising instructions, the instructions when executed by a processor cause the processor to perform the method of claim 14.
